(19) United States
(12) Patent Application Publication
(10) Pub. No.: US 2013/0109557 A1
(43) Pub. Date: May 2, 2013

(54) DEVICE AND METHOD FOR GUIDING BANDS TO BE JOINED TO ONE ANOTHER ALONG THEIR LONGITUDINAL EDGES

(71) Applicants: Martin Retzbach, Ravensburg (DE); Stefan Wischmann, Berlin (DE); Jens Plha, Dusseldorf (DE); Walter Mühlhause, Geldern (DE)

(72) Inventors: Martin Retzbach, Ravensburg (DE); Stefan Wischmann, Berlin (DE); Jens Plha, Dusseldorf (DE); Walter Mühlhause, Geldern (DE)

(73) Assignees: THYSSENKRUPP STEEL EUROPE AG, Duisberg (DE); THYSSENKRUPP LASERTECHNIK GMBH, Ravensburg (DE)

(21) Appl. No.: 13/574,869

(22) PCT Filed: Dec. 23, 2010
(86) PCT No.: PCT/EP10/70685

§ 371 Date: Nov. 16, 2012

(30) Foreign Application Priority Data
Jan. 25, 2010 (DE) 102010005758.4

(51) Int. Cl. B31D 99/00

(52) U.S. Cl. CPC B31D 99/00
USPC 493/381

(57) ABSTRACT

A device and a method for guiding bands to be joined to one another along their longitudinal edges, in which bands are guided via deflection rollers to a joining position. The device according to the invention provides that the deflection roller located closer to the joining position is configured as a conical roller, the deflection roller arranged upstream of this conical roller in the running direction of the band being also configured as a conical roller or as a deflection roller having a cylindrical lateral surface, and the conical roller last mentioned tapering in the direction of the other longitudinal edge of the band, or the rotational axis of the deflection roller having a cylindrical lateral surface spatially approaching the rotational axis of the conical roller arranged downstream in the running direction of the band on the edge side of the band opposing the longitudinal edge to be joined.

The invention relates to a device for guiding bands to be joined to one another along their longitudinal edges, with at least two deflection rollers arranged offset with respect to one another for at least one of the bands. In particular, the invention relates to a method for guiding bands to be joined to one another along their longitudinal edges, in which bands running substantially in parallel with spacing from one another are guided via deflection rollers to a joining position.

In the guiding of bands for joining systems, in particular welding systems for producing non-continuous or continuous bands, the need generally exists in terms of the method for a wedge-shaped joining angle (feed angle) between the bands (joining partners) to be joined to one another along their longitudinal edges, with subsequent parallelism of the longitudinal edges behind the joining point.

Various devices for guiding bands are known, in which flat bands of a different thickness, width and/or material quality can be welded edge to edge along their longitudinal edges to form non-continuous or continuous bands.

A device for the controlled guidance of bands and butt welding them along their longitudinal edges is known from DE 40 22 062 C1 and has axially movably controllable deflection rollers for each band, of which the last deflection rollers in the running direction of the band before the weld position are height- adjustable with their parallel axes relative to one another to such an extent that the bands guided via the deflection rollers, with their longitudinal edges, are in the desired position with respect to one another for the welding and are located in the same vertical plane. The last deflection rollers before the weld point are laterally offset with respect to one another to such an extent that spacing remains between their opposing end faces, the weld beam of a laser welding mechanism being directed onto the weld position between the last deflection rollers. One of these last deflection rollers is displaceably mounted with respect to its height position and the other is displaceably mounted with respect to its axial direction.

A device for guiding steel bands and for continuous butt-joining along their longitudinal edges by means of laser welding is disclosed in JP 11285874 A. In this case, two steel bands are guided in such a way that they approach one another with the formation of a wedge-shaped joining or feed angle in the same transporting plane and their longitudinal edges to be welded to one another rest on one another from the contact point onward without a gap and without an overlap. For this purpose, the device for each of the two bands has a plurality of transport rollers before the weld position, which define a common transporting plane. Furthermore, a first horizontal guide element is provided, on which a first of the two bands rests with its longitudinal edge to be welded, this first band being guided by a further (first) horizontal guide element, which presses against the outer longitudinal edge not to be welded of the band, onto the axis running through the weld position. Shortly before the contact point of the two bands, the longitudinal edge to be welded of the other or second band is pressed by means of a further or second horizontal guide element, which presses against the outer longitudinal edge not to be welded of the second band, against the longitudinal edge to be welded of the first band. In addition, at least one of the last transport rollers before the contact point of the two bands can be oriented obliquely with respect to the running direction of the band in order to direct the band against the other band.

If relatively thick bands and/or bands with high-strength or extremely high-strength qualities are butt welded to one another continuously along their longitudinal edges to form non-continuous or continuous bands, the wedge-shaped joining angle (feed angle) can generally not be adjusted without plastic deformation of at least one of the bands and therefore undesired changes to the mechanical properties; this applies, in particular, to the device known from JP 11285874 A.

The object of the present invention is to disclose a device and a method of the type mentioned at the outset, which make it possible to produce the necessary wedge-shaped joining angle (opening angle) even when joining relatively thick bands and/or bands with high-strength qualities, without plastic deformation of one of the bands occurring in the process.

A device having the features of claim 1 is proposed to achieve this object. The device according to the invention has at least two deflection rollers arranged offset with respect to one another for at least one of bands, the deflection roller located closer to the joining position being configured as a conical roller, which tapers in the direction of the longitudinal edge of the band to be joined, the deflection roller arranged upstream of this conical roller in the running direction of the band being also configured as a conical roller or as a deflection roller having a cylindrical lateral surface, and the conical roller last mentioned tapering in the direction of the other longitudinal edge of the band or the rotational axis of the deflection roller having a cylindrical lateral surface spatially approaching the rotational axis of the conical roller arranged downstream in the running direction of the band on the edge side of the band opposing the longitudinal edge to be joined.

The necessary wedge-shaped joining angle (opening angle) can also be produced when joining relatively thick bands and/or bands with high-strength qualities by means of this roller arrangement using at least one conical roller, without a plastic deformation of one of the bands occurring.

An advantageous configuration of the device according to the invention is that at least one of the deflection rollers is configured as an axially movably controllable deflection roller or conical roller, so that it is substantially radially, in particular horizontally, displaceable. By means of a corresponding displacement or spatial position change of the deflection roller, which is configured as a conical roller or as having a cylindrical lateral surface, the wrap angle of the band on the deflection rollers is changed or adjusted. As a result, the wedge-shaped joining angle between the bands to be connected to one another can be adjusted at the same time.

A further preferred configuration of the device according to the invention provides that the conical roller located closer to the joining position is configured as a height-movable conical roller. When joining bands of a different thickness, this configuration makes it possible to freely select the position of the thickness change.

The two bands to be joined along their longitudinal edges are preferably guided in the same manner in each case. The device according to the invention therefore preferably comprises at least two further deflection rollers arranged offset with respect to one another for the second band of the bands to be joined to one another, the deflection roller located closer to the joining position being in turn configured as a conical roller, which tapers in the direction of the longitudinal edge of the second band to be joined, the deflection roller arranged upstream of this conical roller in the running direction of the second band being also configured as a conical roller or as a deflection roller having a cylindrical lateral surface and this conical roller last mentioned tapering in the direction of the other longitudinal edge of the second band, or the rotational axis of the deflection roller having a cylindrical lateral surface spatially approaching the rotational axis of the conical roller arranged downstream in the running direction of the second band on the edge side of the second band opposing the longitudinal edge to be joined.

As regards the method, the above-mentioned object is achieved by a method having the features of claim 7. In accordance with the device according to the invention, the method according to the invention, in which bands running substantially in parallel with spacing from one another are guided via deflection rollers to a joining position, is characterised in that at least one of the bands is deflected by means of a conical roller or a deflection roller having a cylindrical lateral surface in such a way that it runs toward the other band and, with the latter, defines a wedge-shaped joining angle, the deflected band then being deflected by means of a conical roller, which tapers in the direction of the longitudinal edge of the band to be joined in such a way that the bands to be joined touch along their longitudinal edges and then run parallel to one another. If necessary, a prepositioning of the bands may take place in order, in particular, to compensate for band inaccuracies.

The bands are preferably deflected in each case by means of a conical roller or a deflection roller having a cylindrical lateral surface in such a way that they run toward the other band and together define a wedge-shaped joining angle, the deflected bands then being deflected in each case by means of a conical roller, which tapers in the direction of the longitudinal edge of the respective band to be joined in such a way that the bands to be joined touch along their longitudinal edges and then run parallel to one another.

If the welding takes place using a laser, it must be ensured that a technical zero gap is present. Alternatively, the welding can also take place by means of high frequency. For this purpose, however, a defined force has to be applied at the contact point of the longitudinal edges to be welded, to ensure a perfect material connection of the edges to be connected. The defined force to be applied may be determined as necessary and is, in particular, to be adapted to the material to be welded. The defined force maximally corresponds to the yield strength of the materials to be welded at room temperature, care having to be taken that the yield strength in the zone of heat influence decreases as the temperature increases in order to ensure a real zero gap.

The wedge-shaped joining angle can be adjusted in the method according to the invention by radial, in particular horizontal, displacement of the deflection roller or deflection rollers relative to the conical roller(s) located closer to the joining position.

The band guidance according to the invention is therefore distinguished by a wedge-shaped joining. In particular, it offers the possibility of adjusting the joining angle. Furthermore, the band guidance according to the invention can be used independently of linear joining edges.

Further preferred and advantageous configurations of the device according to the invention or of the method according to the invention are disclosed in the dependent claims.

The bands can be guided free of tension, or may have a tensile force applied.

The invention will be described in more detail below with the aid of drawings showing a plurality of embodiments. In schematic illustration:

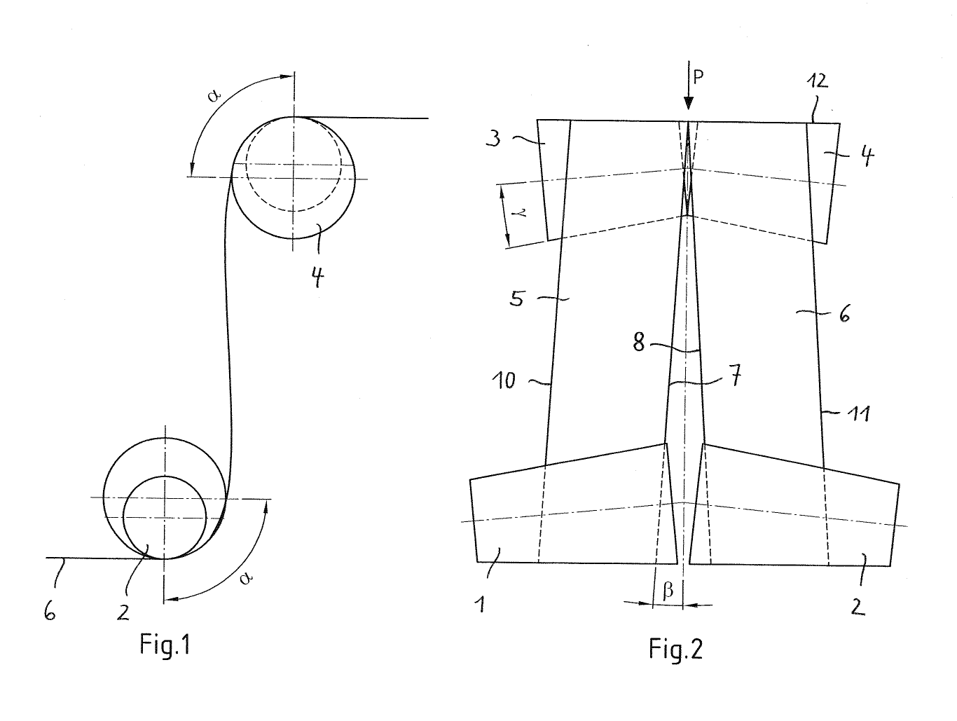

FIG. 1 shows a first embodiment of a device according to the invention with two pairs of conical rollers for guiding bands to be joined to one another along their longitudinal edges, in a side view;

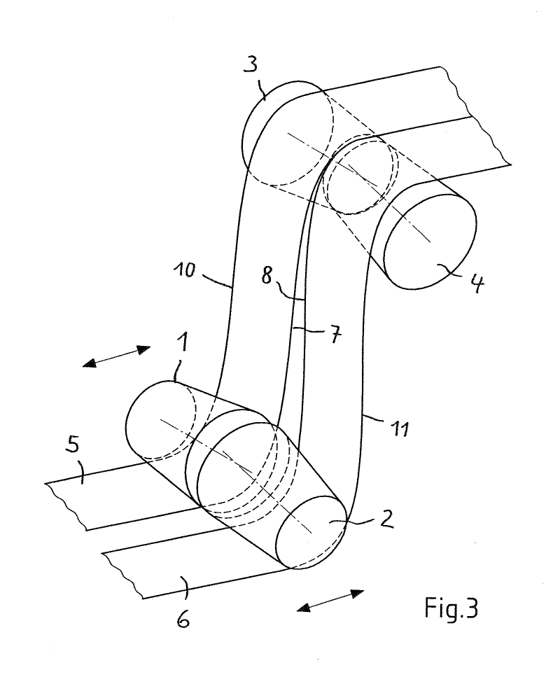

FIG. 2 shows the device of FIG. 1 in a front view;

FIG. 3 shows the device of FIG. 1 in a perspective front view;

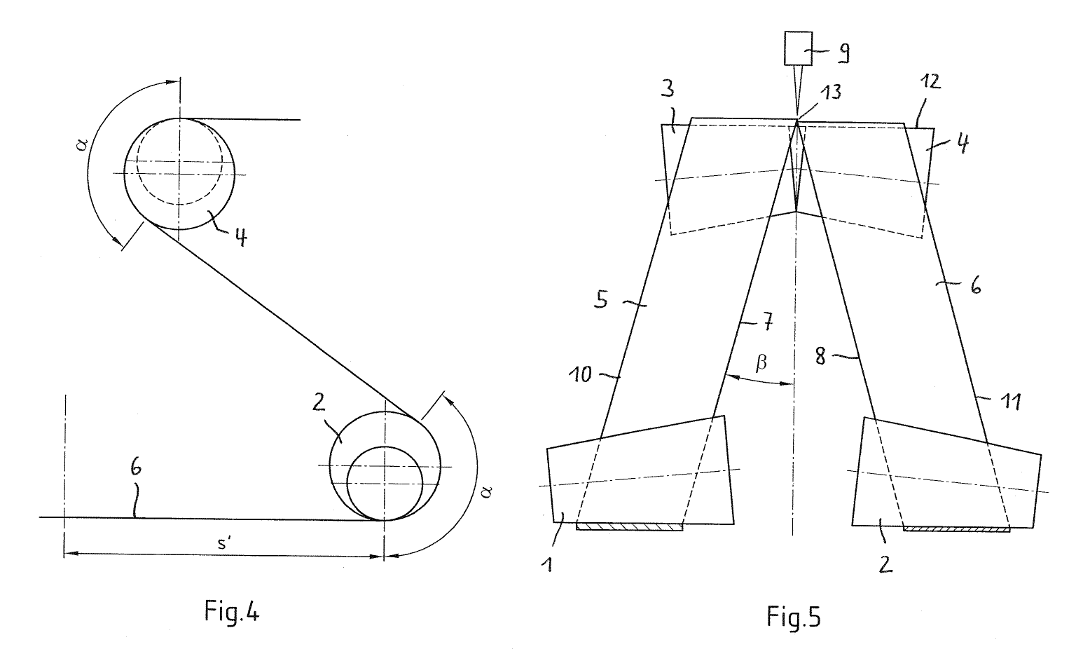

FIG. 4 in turn shows the device of FIG. 1 in a side view, the lower conical rollers being displaced, however, relative to the upper conical rollers, so that the respective wrap angle is increased relative to the adjustment shown in FIG. 1;

FIG. 5 shows the device with the adjustment of the conical rollers according to FIG. 4 in a front view; and

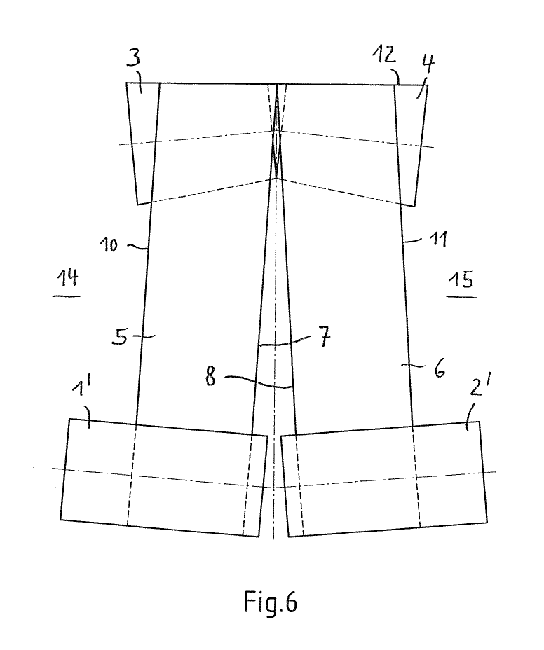

FIG. 6 shows a further embodiment of a device according to the invention with two cylindrical deflection rollers and two conical rollers following in the band running direction to guide bands to be joined to one another along their longitudinal edges, in a front view.

The device shown in FIGS. 1 to 5 comprises deflection rollers 1, 2, 3, 4 which are arranged offset with respect to one another, preferably offset with respect to height, to guide bands 5, 6, which are to be joined to one another along their longitudinal edges 7, 8 abutting edge to edge. The bands 5, 6 are flat, i.e. substantially two-dimensional metal bands, for example steel or aluminum bands. The bands 5, 6 may have a different thickness, width and/or material quality. FIG. 5 shows bands, 5, 6 of a different thickness, by way of example.

The bands 5, 6 are generally unwound from a coil in a reeling station (not shown) and fed via the deflection rollers 1, 2, 3, 4 to a joining apparatus 9, for example a high-frequency welding apparatus or a laser welding apparatus. The joining or welding point is marked in FIG. 2 by the arrow provided with the reference numeral P. During the high-frequency welding, a real zero gap has to be present, which can be adjusted (gaplessly) by means of a defined force at the contact point. During the laser welding, a technical zero gap has to be present for a perfect weld seam.

Proceeding from the reeling stations (not shown), the bands 5, 6 firstly run substantially in parallel and with spacing from one another in the direction of the deflection rollers 1, 2.

The deflection rollers 1, 2 are configured as conical rollers. The bands 5, 6. are deflected to the following rollers 3, 4 by means of the conical rollers 1, 2. The conical rollers 1, 2 taper in the direction of the outer longitudinal edges 10, 11 not to be welded to one another of the bands 5, 6. Owing to the opposingly oriented tapering of the conical rollers 1, 2, the bands 5, 6 run toward one another in the direction of the following conical rollers 3, 4. The conical rollers 3, 4 located closer to the joining position (joining point P) taper in the direction of the longitudinal edges 7, 8 of the bands 5, 6 to be welded to one another. As is to be seen, in particular in FIGS. 1, 2, 4 and 5, the rotational axes of the conical rollers 3, 4 are set with respect to one another in such a way that the lateral surfaces of the conical rollers 3, 4 in the region of the discharge of the bands 5, 6 from the rollers 3, 4 lie in a common band transporting plane 12.

At least one of the conical rollers 3, 4 located closer to the joining position P is preferably configured as a height-movable conical roller. The position of the thickness change 13 can be influenced by a height adjustment of the conical rollers 3, 4 relative to one another when welding bands 5, 6 of different thickness (cf. FIG. 5).

Since in the arrangement according to FIG. 5, the rotational axes of the conical rollers 3, 4 are set with respect to one another in such a way that the lateral surfaces of the conical rollers 3, 4 are located in a common band transporting plane 12, in this arrangement, the thickness change 13 is located on the band side remote from the conical rollers 3, 4. However, a roller arrangement, in which the lateral surfaces of the conical rollers 3, 4 are located in different band transporting planes that are parallel to one another, can also be achieved by a height adjustment of the conical rollers 3, 4 relative to one another. For example, the rotational axes of the conical rollers 3, 4 of the device according to the invention can be positioned with respect to one another in such a way that a thickness change is produced on the two band sides of the bands welded to one another, in each case. Further, it is within the scope of the present invention to adjust the position of the conical rollers 3, 4 relative to one another during the joining or welding process so that a thickness change from one band side to the other band side and optionally back again, in particular a sinusoidal thickness change is produced on the band produced from the bands 5, 6.

As an alternative or in addition to a height adjustability of the conical rollers 3, 4, tensioning rollers (not shown), which are height-adjustable relative to one another, may be arranged downstream of the conical rollers 3, 4 in the running direction of the bands 5, 6 to select the position of the thickness change. The position of the thickness change can also be influenced by means of height-adjustable tensioning rollers of this type.

The point, at which the longitudinal edges 7, 8 of the bands 5, 6, which are to be welded to one another, abut one another, is located at or shortly before the point, at which the lateral surfaces of the conical rollers 3, 4 are located in the common band transporting plane 12 or in the band transporting planes that are parallel to one another. The bands 5, 6 then run onward in parallel with longitudinal edges 7, 8 located against one another or joined to one another.

The bands 5, 6 are preferably welded at their contact point, in other words at the point, at which the lateral surfaces of the conical rollers 3, 4 are located in the common band transporting plane or in the band transporting planes that are parallel to one another. However, it is also within the scope of the invention to provide the joining or welding point P spaced further apart from the first contact point of the bands 5, 6.

The joining angle (opening angle) β is a function of the cone angle γ and of the wrap angle α of the band 5 or 6 at the respective conical roller 1, 2, 3, 4. The joining angle β is, in particular, structurally pre-adjusted by the use of conical rollers 3, 4 having a specific cone angle γ (cf. FIG. 2).

Moreover, the conical rollers 1, 2 are axially movably mounted so that they are axially, as well as substantially radially, in particular horizontally, displaceable. By displacing or changing the position of the conical rollers 1, 2 relative to the following conical rollers 3, 4, the wrapping of the band 5, 6 around the conical roller, in other words the wrap angle α of the band 5 or 6 on the conical rollers 1, 3 or 2, 4, and therefore simultaneously the joining angle (opening angle) β, is changed.

In the embodiment shown in FIG. 1, the wrap angle α is about 90°. The cone angle γ of the conical roller 3, 4 located closest to the joining position P is in the range of 5° to 10° and, for example, is about 7°. The joining angle β is in this case about 3.5°.

By displacing the lower conical rollers 1, 2 by a distance s′, the wrap angle α is increased. In this case, the spacing of the lower conical rollers 1, 2 from one another and the joining angle β are simultaneously increased (cf. FIGS. 4 and 5). With an increase in wrap angle α, the joining angle β increases. The position of the joining or welding point P does not change in this case.

The device according to the invention therefore allows a change in the wrap angle α or joining angle β by changing the position of the conical rollers 1, 2 relative to the following conical rollers 3, 4. In particular, by changing the position of the conical rollers 1, 2 relative to the following conical rollers 3, 4, the effective pressing force (joining force) on the mutually abutting longitudinal edges 7, 8 of the bands 5, 6 can be influenced, and a defined force can be adjusted, in particular, to adjust a real zero gap.

The embodiment shown in FIG. 6 of the device according to the invention differs from the embodiment according to FIGS. 1 to 5 in that the deflection rollers 1′, 2′ arranged upstream of the conical rollers 3, 4 in the running direction of the bands 5, 6 are configured as a deflection roller with a cylindrical lateral surface. The conical rollers 3, 4 and the cylindrical deflection rollers 1′, 2′ are arranged, in this case, in relation to the respective band in such a way that the rotational axis of the cylindrical deflection roller 1′ or 2′ spatially approaches the rotational axis of the conical roller 3 or 4 following in the band running direction on the edge side 14 or 15 of the band 5 or 6 opposing the longitudinal edge 7 or 8 to be welded. The rotational axes of the cylindrical deflection rollers 1′, 2′ together form an obtuse angle. The conical rollers 3, 4 are in turn set with respect to one another in such a way that their lateral surfaces are located in a common band transporting plane 12.

The device according to the invention according to FIGS. 1 to 5 or FIG. 6 can furthermore be provided with band edge control mechanisms (not shown), which bring about a positioning of the longitudinal edges (joining edges) 7, 8 to be welded to one another in the system centre.

The configuration of the invention is not limited to the embodiments described above and shown in the drawings. Rather, a plurality of variants are conceivable, which also make use of the invention disclosed in the accompanying claims even with a basically deviating configuration. Thus, for example, the deflection or conical rollers 1, 2, 3, 4 or 1′, 2′, 3, 4 may also be arranged in such a way that the bands 5, 6 that initially run in parallel with spacing from one another are guided downward via the conical or cylindrical deflection rollers 1, 2 or 1′, 2′. However, in this case, it is also ensured by a suitable spatial arrangement of the conical or cylindrical deflection rollers 1, 2 or 1′, 2′, that the bands 5, 6 then run toward one another and touch in the region of the common band transporting plane 12 or the band transporting planes that are parallel to one another of the conical rollers 3, 4 which are then arranged lower.

Furthermore, the advantages of the device according to the invention can also be utilised if only one half of the roller arrangements shown in FIG. 1 to 5 or 6, in other words the roller arrangement for one of the two bands 5 or 6, is combined with a differently configured band guidance for the other band 6 or 5. Thus, for example, a conventional roller course (not shown) to guide one of the bands 5 or 6 may be combined with a roller arrangement according to the invention, comprising two conical rollers 2, 4 or 1, 3 following one another in the running direction of the band 6 or 5 and tapering in opposing directions, the first roller 1 or 2 viewed in the running direction of the band 5 or 6 tapering with respect to the outer longitudinal edge 10 or 11 not to be welded of the band 5 or 6, and the lateral surface of the following conical roller 3 or 4 together with the lateral surface of an adjacent cylindrical roller (not shown) of the roller course being located in a common band transporting plane 12.

1. A device for guiding a first and a second band to be joined to one another along their first longitudinal edges with at least two deflection rollers arranged offset with respect to one another for at least the first band, wherein a first deflection roller located closer to a joining position is configured as a first conical roller, which tapers in the direction of the first longitudinal edge of the first band to be joined, a second deflection roller arranged upstream of the first conical roller in the running direction of the first band being also configured as a second conical roller or as a second deflection roller having a cylindrical lateral surface, and the second conical roller tapering in the direction of a second longitudinal edge of the first band, or the rotational axis of the second deflection roller having a cylindrical lateral surface spatially approaching the rotational axis of the first conical roller arranged downstream in the running direction of the band on a first edge side of the first band opposing the first longitudinal edge to be joined.

2. The device according to claim 1, wherein at least one of the second deflection rollers s configured as an axially movably controllable deflection roller or conical roller, so that it can be displaced substantially radially.

3. The device according to claim 1, wherein the first conical roller located closer to the joining position is configured as a height-movable conical roller.

4. The device according to claim 1, wherein at least two further deflection rollers arranged offset with respect to one another for the second band of the bands (5, 6) to be joined to one another are present, a third deflection roller located closer to the joining position being configured as a third conical roller, which tapers in the direction of the first longitudinal edge of the second band to be joined, a fourth deflection roller arranged upstream of the third conical roller in the running direction of the second band being also configured as a fourth conical roller, or as a fourth deflection roller having a cylindrical lateral surface, and this the fourth conical roller tapering in the direction of the second longitudinal edge of the second band, or the rotational axis of the fourth deflection roller having a cylindrical lateral surface spatially approaching the rotational axis of the third conical roller arranged downstream in the running direction of the second band on the second edge side of the second band opposing the first longitudinal edge to be joined.

5. The device according to claim 4, wherein the lateral surfaces of the first and third conical rollers located closer to the joining position are located in a common plane.

6. The device according to claim 4, wherein tensioning rollers, which are height-adjustable relative to one another, are arranged downstream of the first and third conical rollers located closer to the joining position in the running direction of the first and second bands to be joined to one another.

7. A method for guiding a first and second band to be joined to one another along their first longitudinal edges, in which the first and second bands running substantially in parallel with spacing from one another are guided via deflection rollers to a joining position, wherein the first band is deflected by means of a first conical roller or a first deflection roller having a cylindrical lateral surface in such a way that it runs toward the second band and, with the second band, defines a wedge-shaped joining angle, the first band then being deflected by means of a second conical roller, which tapers in the direction of the first longitudinal edge of the first band to be joined in such a way that the first and second bands to be joined touch along their first longitudinal edges and then run parallel to one another.

8. The method according to claim 7, wherein the first and second bands are in each case deflected by means of a the first conical roller and a third conical roller or a the first deflection roller and a third deflection roller having a cylindrical lateral surface in such a way that the first and second bands run toward one another and together define a wedge-shaped joining angle the deflected bands then being deflected, in each case, by means of the second conical roller and a fourth conical roller, which tapers in the direction of the first longitudinal edge to be joined of the respective band in such a way that the first and second bands to be joined touch along their first longitudinal edges and then run parallel to one another.

9. The method according to claim 7, wherein the joining angle is adjusted by radial, displacement of the first deflection roller or first and third deflection rollers relative to the second conical roller or second and fourth conical rollers located closer to the joining position.

10. The method according to claim 8, wherein the joining angle is adjusted by changing the wrap angles of the first and second bands on the deflection rollers and/or conical rollers.

11. The method according to claim 9, wherein a defined force is adjusted by changing a position of the first and third conical rollers relative to the second and third conical rollers (3, 4) at the abutting first longitudinal edges of the first and second bands.
